(19) United States
(12) Patent Application Publication
(10) Pub. No.: US 2019/0289140 A1
(43) Pub. Date: Sep. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Takeshi FUKUI, Kanagawa (JP)

(73) Assignee: FUJI XEROX CO., LTD., Tokyo (JP)

(21) Appl. No.: 16/293,594

(22) Filed: Mar. 5, 2019

(30) Foreign Application Priority Data
Mar. 15, 2018 (JP) 2018-048541

(51) Int. Cl. H04N 1/00; G06F 3/12

(52) U.S. Cl. CPC H04N 1/00068; G06F 3/1207; H04N 1/00708; H04N 1/00724; G06F 3/1212

(57) ABSTRACT

An information processing apparatus includes an obtaining unit and a calculation unit. The obtaining unit obtains sheet information about sheets accommodated in a sheet accommodation unit among sheet accommodation units in accordance with a print condition specified in a print to perform printing in accordance with the print instruction on the basis of the print condition and the sheet information.

### CROSS-REFERENCE TO RELATED APPLICATIONS

This application is based on and claims priority under 35 USC 119 from Japanese Patent Application No. 2018-048541 filed Mar. 15, 2018.

### BACKGROUND

### (i) Technical Field

The present disclosure relates to an information processing apparatus and a non-transitory computer readable medium.

### (ii) Related Art

As an apparatus for calculating a print time taken for a print job, for example, Japanese Unexamined Patent Application Publication No. 2012-63951 discloses a print control apparatus that includes a sheet-type-specific print speed table, a print time calculation means, and a first display control means. The sheet-type-specific print speed table indicates a print speed for each sheet type on a per printer basis. The print time calculation means refers to the sheet-type-specific print speed table and calculates a print time taken for a print job when printing is performed at a print speed that matches sheets used in the print job.

The first display control means displays the print job in a predetermined display form having a length proportional to the calculated print time.

### SUMMARY

There is a case where a time taken for printing is estimated before printing is actually performed by a printer to, for example, schedule a print operation. However, print conditions specified in a print instruction might not include information for estimating the print time, and it may be difficult to calculate the time taken for printing.

Aspects of non-limiting embodiments of the present disclosure relate to a technique for more accurately calculating a time taken to perform printing in accordance with a print instruction by using print conditions specified in the print instruction.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an obtaining unit and a calculation unit. The obtaining unit obtains sheet information about sheets accommodated in a sheet accommodation unit among sheet accommodation units in accordance with a print condition specified in a print instruction. The calculation unit calculates a time taken to perform printing in accordance with the print instruction on the basis of the print condition and the sheet information.

### BRIEF DESCRIPTION OF THE DRAWINGS

An exemplary embodiment of the present disclosure will be described in detail based on the following figures, wherein:

FIG. 1 is a diagram illustrating an example overall configuration of an image forming system according to an exemplary embodiment;

FIG. 2 is a diagram illustrating an example external view of an image forming apparatus according to the exemplary embodiment;

FIG. 3 is a diagram illustrating an example internal structure of the image forming apparatus according to the exemplary embodiment;

FIG. 4 is a diagram for describing connections between a control device and other constituent units;

FIG. 5 is a block diagram illustrating an example functional configuration of the control device of the image forming apparatus according to the exemplary embodiment;

FIGS. 6A and 6B are diagrams illustrating example condition-specific speed tables;

FIG. 7 is a flowchart illustrating an example procedure for the control device of the image forming apparatus to calculate a print time;

FIGS. 8A to 8D are diagrams for describing specific example processes for calculating the number of sheets on which printing is performed on the basis of a target job;

FIG. 9 is a diagram for describing a specific example process for calculating a first-sheet size in a case where printing is performed on the basis of a target job;

FIG. 10 is a diagram illustrating example sheets accommodated in sheet accommodation units;

FIGS. 11A to 11C are diagrams for describing example processes for selecting a print speed;

FIG. 12 is a diagram for illustrating an example process for transmitting a print time to a server apparatus; and

FIG. 13 is a diagram illustrating an example hardware configuration of a computer to which the exemplary embodiment is applicable.

### DETAILED DESCRIPTION

Hereinafter, an exemplary embodiment of the present disclosure will be described in detail with reference to the attached drawings.

### Overall Configuration of Image Forming System

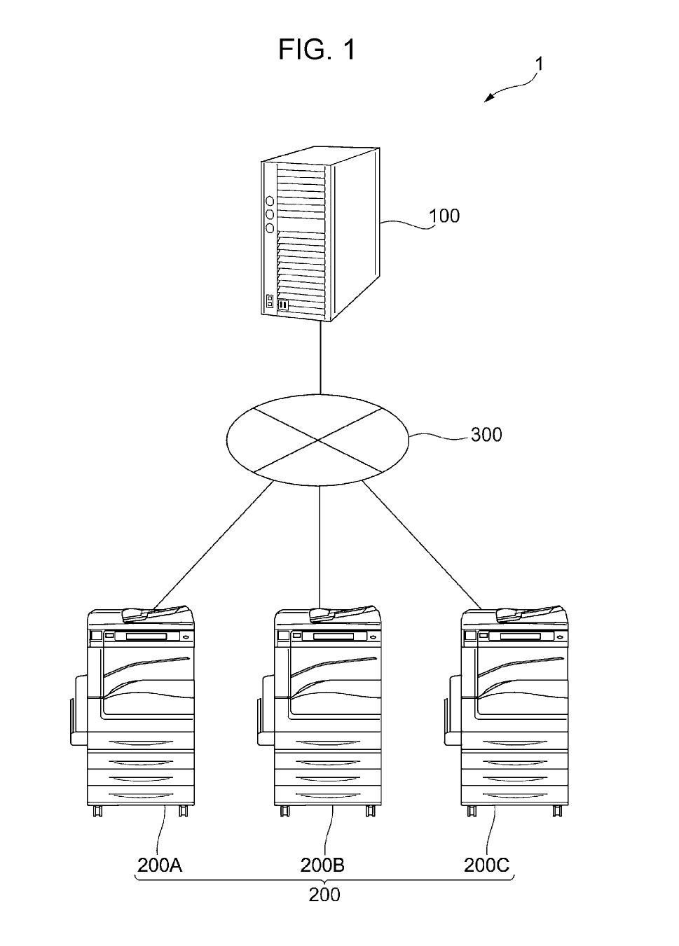

First, the overall configuration of an image forming system 1 according to this exemplary embodiment is described. FIG. 1 is a diagram illustrating an example overall configuration of the image forming system 1 according to this exemplary embodiment. As illustrated in FIG. 1, the image forming system 1 includes a server apparatus 100 and image forming apparatuses 200A to 200C. The server apparatus 100 and the image forming apparatuses 200A to 200C are connected to a network 300.

The image forming apparatuses 200A to 200C illustrated in FIG. 1 may be simply referred to as image forming apparatuses 200 if these apparatuses need not be distinguished from each other. Further, FIG. 1 illustrates the example case of three image forming apparatuses 200; however, the number of the image forming apparatuses 200 is not limited to three as in the illustrated example. In this exemplary embodiment, the image forming apparatuses 200 are each used as an example of the information processing apparatus.

The server apparatus 100 is a computer that manages print processing in the image forming apparatuses 200. Examples of the server apparatus 100 include a personal computer (PC) and a workstation. Specifically, the server apparatus 100 collects, from each image forming apparatus 200, a time taken to perform printing in accordance with a print job input to the image forming apparatus 200. Hereinafter, a time taken to perform printing in accordance with a print job is referred to as “print time”. The server apparatus 100 displays the collected print time of each image forming apparatus 200 on, for example, a screen to thereby inform the administrator of the image forming system 1 of the print time. The administrator needs to check and use the print time of each image forming apparatus 200 to schedule a print operation. For example, the administrator may schedule a print operation so as to input a print job preferentially to the image forming apparatus 200 for which the print time is shorter than those of the other image forming apparatuses 200.

Here, the print job is an example of the print instruction and is data that serves as a unit of print processing performed by the image forming apparatus 200. The print job includes image data that is a print target and print conditions that are specified as conditions for printing. The print conditions include, for example, the number of pages of a document, the number of copies, information about, for example, a sheet accommodation unit that is specified to be used in printing, and sheet information about sheets to be used in printing. The sheet information is information about a sheet type indicating the type of sheets and includes information about the paper type, weight (basis weight), color, and so on of sheets. The basis weight is the weight of a sheet per 1 m². As a sheet is heavier, the thickness of the sheet tends to increase, and therefore, the basis weight is used as a synonym of the sheet thickness.

The print job may be transmitted from the server apparatus 100 to the image forming apparatus 200, or the print job may be transmitted from an apparatus (not illustrated) other than the server apparatus 100 to the image forming apparatus 200.

Each image forming apparatus 200 is an apparatus that forms an image on a sheet, which is an example of a recording medium, to perform printing. Each image forming apparatus 200 allows the use of a plurality of types of sheets and performs printing on the basis of a print job input from the server apparatus 100 or another apparatus. Each image forming apparatus 200 has a function of calculating (estimating) a print time in accordance with a print job and transmits the calculated print time to the server apparatus 100.

More specifically, each image forming apparatus 200 calculates a print time for a print job on the basis of print conditions specified in the print job and sheet information about sheets accommodated therein (image forming apparatus 200). The details of a process for calculating the print time will be described below. As the image forming apparatus 200, an apparatus having only a print function may be used, or an apparatus having other image processing functions, such as a copy function, a scan function, and a facsimile function, in addition to a print function may be used.

The network 300 is a communication means used in information communication between the server apparatus 100 and the image forming apparatuses 200 and is, for example, the Internet, a public line, or a local area network (LAN).

### Configuration of Image Forming Apparatus

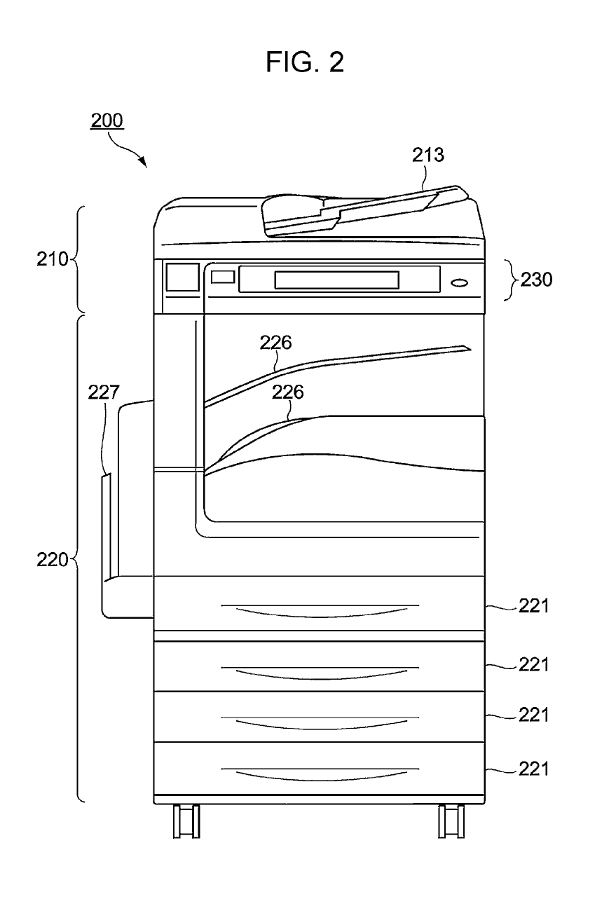

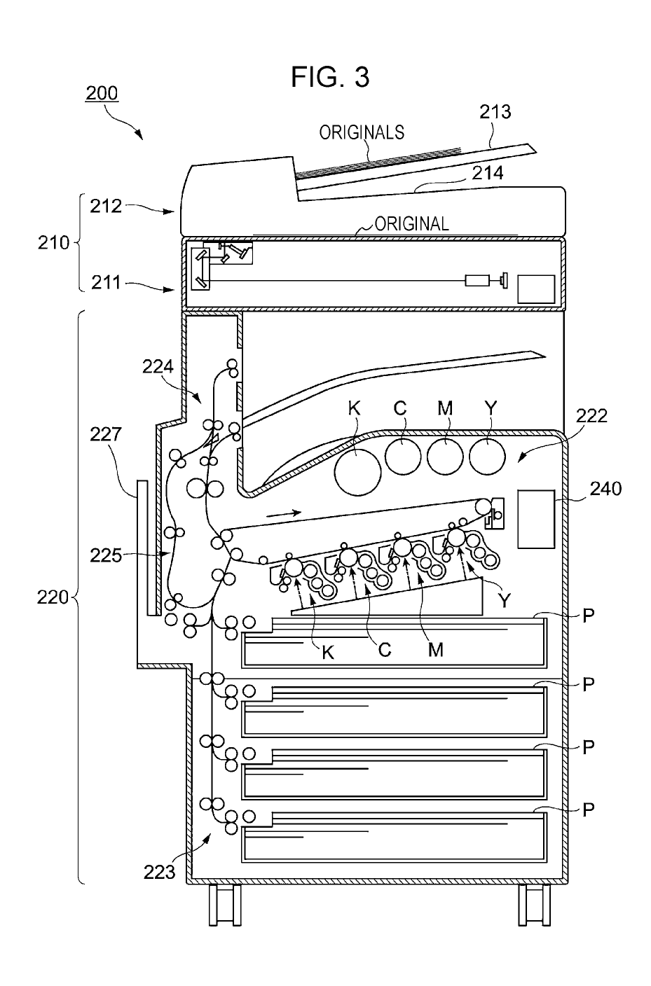

Next, the configuration of the image forming apparatus 200 according to this exemplary embodiment is described. FIG. 2 is a diagram illustrating an example external view of the image forming apparatus 200 according to this exemplary embodiment. FIG. 3 is a diagram illustrating an example internal structure of the image forming apparatus 200 according to this exemplary embodiment.

The image forming apparatus 200 includes an image reading device 210 that reads an image of an original and an image recording device 220 that records the image on a sheet. The image forming apparatus 200 further includes a user interface (UI) 230 that is used to accept operations by a user and present various types of information to the user. The image forming apparatus 200 further includes a control device 240 that controls overall operations of the image forming apparatus 200. In this exemplary embodiment, the control device 240 may be regarded as an example of the information processing apparatus.

The image reading device 210 is installed on the image recording device 220 that constitutes the body of the image forming apparatus 200. The image reading device 210 includes an image reading unit 211 that optically reads an image formed on an original and a document feeding unit 212 that feeds an original to the image reading unit 211. The document feeding unit 212 includes a document accommodation unit 213 that accommodates originals and a document catch unit 214 to which an original taken from the document feeding unit 212 is ejected, and conveys an original from the document accommodation unit 213 to the document catch unit 214 by using a conveying mechanism not illustrated. Here, the document feeding unit 212 is also called an auto-document feeder (ADF). To read an image of an original, a method of moving an optical reader relative to the original may be used.

The image recording device 220 includes a mechanism for forming an image on the surface of a sheet and a mechanism for conveying the sheet.

The image recording device 220 includes an image forming unit 222, a sheet conveying unit 223, a sheet ejecting unit 224, and a flipping-conveying unit 225. The image forming unit 222 forms an image on a sheet P taken from, for example, a sheet feeding unit 221. The sheet conveying unit 223 conveys the sheet P to the image forming unit 222. The sheet ejecting unit 224 ejects the sheet P on which an image has been formed by the image forming unit 222. The flipping-conveying unit 225 flips the sheet P conveyed from the image forming unit 222 and re-conveys the sheet P to the image forming unit 222.

In the image forming unit 222, recording units that correspond to respective colors of yellow (Y), magenta (M), cyan (C), and black (K) are disposed along the conveyance path of the sheet P.

Each recording unit includes, for example, a photoconductor drum, a charging device that charges the surface of the photoconductor drum, an exposure unit that irradiates the charged photoconductor drum with a laser beam to draw an image, a developing device that develops the drawn image as a toner image, and a transfer unit that transfers the toner image to a transfer belt. The toner images corresponding to the respective colors, which have been transferred to the transfer belt, are eventually transferred to the surface of the sheet P and fixed by a fixing unit. Here, the types and combination of colors are example types and combination.

In the lower portion of the image recording device 220, sheet feeding units 221 for accommodating the sheets P and feeding the sheets P to the image forming unit 222 are disposed. The image forming apparatus 200 further includes a manual feeding unit 227 that allows a user to manually feed the sheets P to the image forming unit 222. The manual feeding unit 227 is closable. A user closes the manual feeding unit 227 when not using the manual feeding unit 227, and opens the manual feeding unit 227 when using the manual feeding unit 227 to set the sheets P. FIG. 2 and FIG. 3 illustrate a state where the manual feeding unit 227 is closed. Hereinafter, the sheet feeding units 221 and the manual feeding unit 227 may be collectively referred to as “sheet accommodation units”.

Further, in the upper portion of the image recording device 220, a plurality of catch trays 226 for catching the sheet P on which an image has been formed are provided.

The UI 230 is disposed on the near side of the image reading device 210 such that the operation surface thereof faces a user who operates the image forming apparatus 200.

The UI 230 includes an operation accepting unit that accepts an instruction from a user and a display unit that presents information to the user. The operation accepting unit has, for example, a function of detecting an operation performed on, for example, hardware keys or software keys. The display unit displays an operation screen, software keys, and so on.

The control device 240 is provided inside the housing of the image recording device 220.

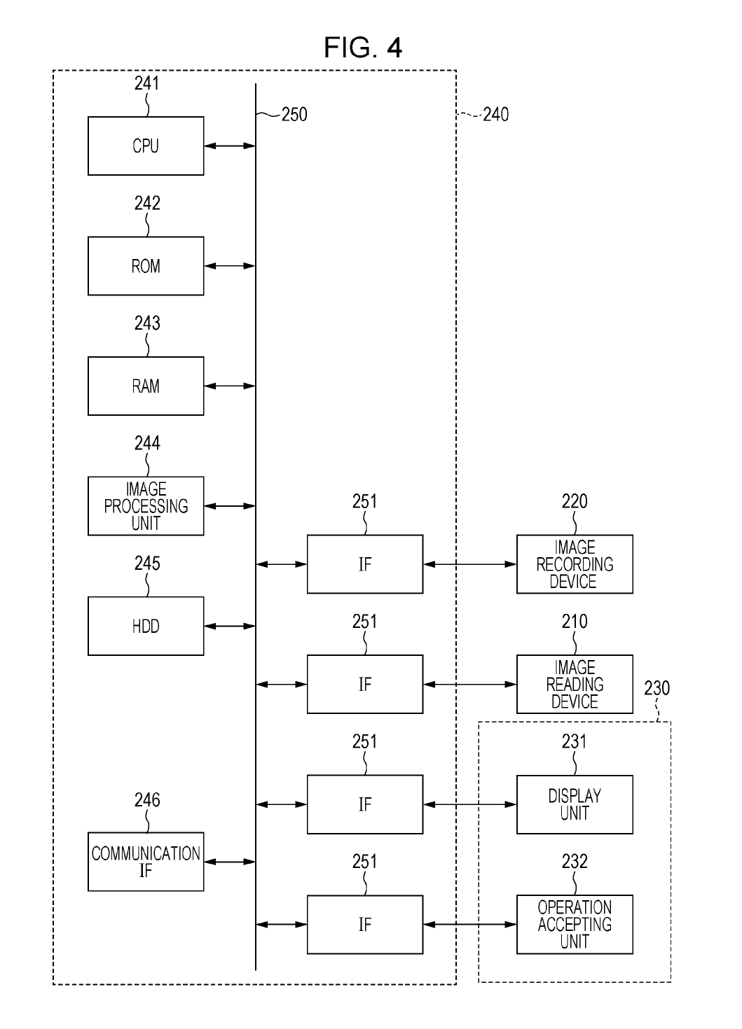

FIG. 4 is a diagram for describing connections between the control device 240 and other constituent units.

The control device 240 includes a central processing unit (CPU) 241, a read-only memory (ROM) 242 that stores, for example, firmware and a basic input/output system (BIOS), and a random access memory (RAM) 243 that is used as a work area of the CPU 241, which constitute a typical computer.

The control device 240 further includes an image processing unit 244 that performs various types of processing (for example, a color correction, a tone correction, and so on) for forming an image. The image processing unit 244 performs image processing by using, for example, the RAM 243.

The control device 240 further includes a hard disk drive (HDD) 245, which is an example of a nonvolatile storage device. In the HDD 245, a print job input from, for example, the server apparatus 100, an image read by the image reading device 210, and so on are saved.

The control device 240 further includes a communication interface (communication IF) 246 for communication with an external apparatus and interfaces (IFs) 251 for connections with the devices and so on within the image forming apparatus 200. The CPU 241 is connected to each unit via a bus 250. The bus 250 may be configured by connecting a plurality of buses via bridges.

In FIG. 4, as example elements that constitute the UI 230, a display unit 231 that is used to display an operation screen and an operation accepting unit 232 that accepts a user operation are illustrated. As the operation accepting unit 232, for example, a touch panel is used. Functional Configuration of Control Device

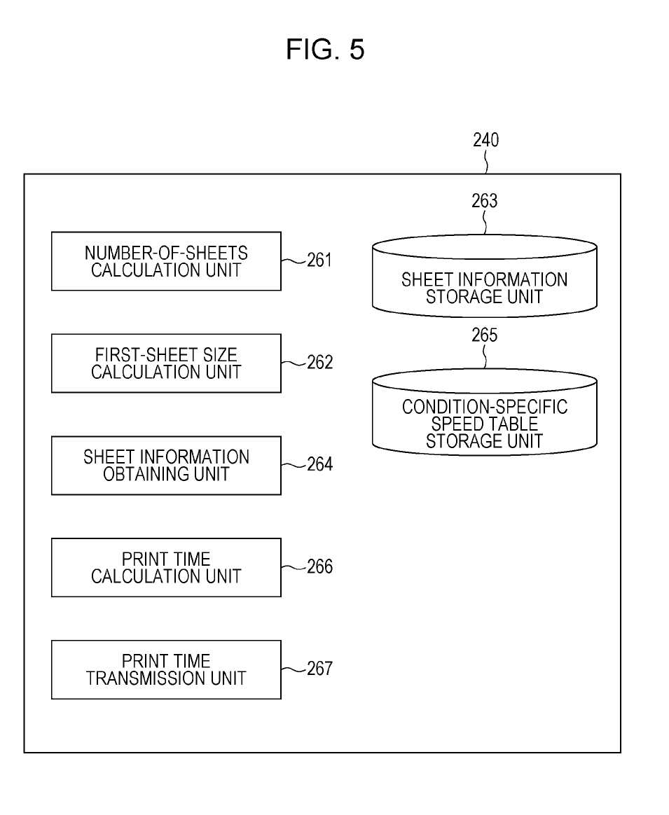

Now, the functional configuration of the control device 240 of the image forming apparatus 200 according to this exemplary embodiment is described. FIG. 5 is a block diagram illustrating an example functional configuration of the control device 240 of the image forming apparatus 200 according to this exemplary embodiment. The control device 240 includes a number-of-sheets calculation unit 261, a first-sheet size calculation unit 262, a sheet information storage unit 263, a sheet information obtaining unit 264, a condition-specific speed table storage unit 265, a print time calculation unit 266, and a print time transmission unit 267.

The number-of-sheets calculation unit 261 calculates, for a target print job (hereinafter sometimes referred to as “target job”) for which the print time is calculated, the number of sheets on which printing is performed on the basis of the target job. More specifically, the number-of-sheets calculation unit 261 calculates the number of sheets on which printing is performed on the basis of print conditions included in the target job. Here, as the print conditions, for example, the number of pages of a document included in the target job, the number of copies, and print settings, such as an imposition/bookbinding method, a print range specification, and a build job, are used. In this exemplary embodiment, the front side and the back side of a sheet are each processed as one page. In a case of printing on both sides of a sheet, the front side of the sheet is counted as one page, and the back side of the sheet is counted as one page. Therefore, the calculated number of sheets is two in total.

Here, the imposition/bookbinding method is a method for bookbinding by performing imposition. Imposition is an operation of arranging images of a plurality of pages on one sheet. In a case where the imposition/bookbinding method is, for example, “saddle stitching”, images for two pages are printed on each of the front side and the back side of each sheet, and the sheets are folded in half along the center line of the sheets and bounded.

The print range specification is a specification of the print range for image data included in the print job. In a case where, for example, the number of pages of a document included in the print job is ten, the print range is specified, such as “first page” or “fifth and subsequent pages”.

The build job is an operation of concatenating a plurality of print jobs. For example, concatenation of a print job for ten pages and a print job for eight pages results in a print job for 18 pages.

After a print job has been input to the image forming apparatus 200, a user is allowed to edit the print job by a user operation. Specifically, for example, the number of pages of a document included in the print job may be increased or decreased by a user operation, or the sheet size or the paper type may be changed by a user operation. For example, a setting of the imposition/bookbinding method or a setting of the build job may be newly added by a user operation, or a print range may be newly specified by a user operation. In a case of calculating the print time after such editing, the number-of-sheets calculation unit 261 calculates the number of sheets for the edited print job.

In a case where raster image processor (RIP) processing has been performed on a print job, all pages of the document has been analyzed by the RIP processing, and therefore, the number of sheets is calculated on the basis of the analysis result. RIP processing is processing for converting image data of the print job created by, for example, a PC to raster data for output as an image. Raster data is image data that represents an image as a series of colored dots.

For example, in a case where a setting of interleaving paper, which is a piece of paper interleaved for, for example, facilitating a quantity check, is specified, the piece of interleaving paper is ejected without an image formed thereon. In a case where all pages of the document have been analyzed by RIP processing, it is possible to know the presence of a sheet (that is, a piece of interleaving paper) for which print target image data is not present. Accordingly, the number of sheets is decreased by the number of pieces of interleaving paper to thereby enable more accurate calculation of the number of sheets on which printing is performed.

RIP processing is processing that is performed as preprocessing before printing, and is performed, for example, at a timing specified by the user. Therefore, print jobs retained by the image forming apparatus 200 include a print job for which RIP processing has been performed and a print job for which RIP processing has not been performed.

The first-sheet size calculation unit 262 calculates the size (hereinafter referred to as “first-sheet size”) of a sheet (that is, the first sheet) on which printing is performed first in a case of printing based on a target job. More specifically, the first-sheet size calculation unit 262 calculates the first-sheet size on the basis of print conditions included in the target job. Here, as the print conditions, for example, the sizes of originals included in the target job and the size for imposition are used. In a case where, for example, the size of an original that is printed first is specified as “A4” and the size for imposition is specified as “SRA3” in a target job, the calculated first-sheet size is “SRA3”. The size “SRA3” is a size larger than the size “A3” and measures 320 mm×450 mm. In a case of calculating the print time for an edited print job, the first-sheet size calculation unit 262 calculates the first-sheet size for the edited print job.

The sheet information storage unit 263 stores sheet information about sheets accommodated in the sheet accommodation units. Here, the sheet information is information about the sheet types of sheets accommodated in the sheet accommodation units and includes, for example, the sheet size, paper type, weight, and color. The sheet information storage unit 263 stores the sheet information as described above for each sheet accommodation unit.

The sheet information is set by, for example, the administrator. A user accommodates sheets in the sheet accommodation units in accordance with the set information. The image forming apparatus 200 may include sensors for sensing, for example, the sheet size, paper type, weight, and color to thereby store information obtained by the sensors in the sheet information storage unit 263.

The sheet information obtaining unit 264 obtains, from the sheet information storage unit 263, sheet information about sheets accommodated in a sheet accommodation unit on the basis of print conditions specified in the target job. Here, as the print conditions, for example, the first-sheet size calculated by the first-sheet size calculation unit 262 or information about a sheet accommodation unit specified, in the target job, to be used in printing is used. In a case where information about a sheet type, such as the paper type, weight, and color of sheets, is specified as the print conditions in the target job, such information is also used.

The print conditions used here are print conditions for a page that is printed first in the target job. For example, there may be a case where a target job includes a page that is printed in accordance with print conditions different from the print conditions for the page that is printed first. Even in such a case, the sheet information obtaining unit 264 obtains sheet information about sheets accommodated in a sheet accommodation unit in accordance with the print conditions for the page that is printed first. More specifically, for example, even in a case where a target job includes a page that is printed in a sheet size different from the first-sheet size, the sheet information obtaining unit 264 obtains sheet information about sheets accommodated in a sheet accommodation unit by using the first-sheet size.

The sheet information obtaining unit 264 obtains, as the sheet information, information about a sheet type that matches print conditions specified in the target job among pieces of information stored in the sheet information storage unit 263 (that is, information about the sheet types of sheets accommodated in the sheet accommodation units). There may be a case where, among the sheet types of sheets accommodated in the sheet accommodation units, a plurality of sheet types match the print conditions specified in the target job. In such a case, the sheet information obtaining unit 264 obtains information about the sheet type of sheets accommodated in the sheet accommodation unit that is actually used in printing for the target job among the plurality of sheet types that match the print conditions specified in the target job.

There may be a case where none of the sheet types of sheets accommodated in the sheet accommodation units match the print conditions specified in the target job. In such a case, the sheet information obtaining unit 264 obtains information about one sheet type among the sheet types of sheets accommodated in the sheet accommodation units in accordance with a predetermined rule. That is, in a case where a sheet type that matches the print conditions specified in the target job is not present, printing is actually not performed due to, for example, an error; however, the sheet information obtaining unit 264 obtains information about a sheet type that is different from the sheet type of sheets that are actually used in printing for the target job for the purpose of estimating the print time.

The predetermined rule is a rule in which, for example, one of the items of the sheet type is set as an item of interest, and the sheet type of sheets for which the item of interest is closest to the content specified in the print job is obtained among the sheet types of sheets accommodated in the sheet accommodation units. For example, in a case where the sheet size is set as an item of interest, the sheet information obtaining unit 264 obtains information about the sheet type of sheets having a size closest to the first-sheet size among the sheet types of sheets accommodated in the sheet accommodation units. The size closest to the first-sheet size may be a size the same as the first-sheet size.

The item of interest is not limited to the sheet size.

For example, in a case where the basis weight is set as an item of interest, the sheet information obtaining unit 264 obtains information about the sheet type of sheets having a basis weight closest to a basis weight specified in the print job among the sheet types of sheets accommodated in the sheet accommodation units. Further, items of interest may be assigned priority levels. For example, in a case where the sheet information obtaining unit 264 first sets the sheet size as an item of interest and finds a plurality of sheet types having a size the same as the first-sheet size, the sheet information obtaining unit 264 subsequently sets the basis weight as an item of interest and obtains information about the sheet type of sheets having a basis weight closest to a basis weight specified in the print job.

In a case where a sheet accommodation unit that is used in printing is specified in a target job, even if the sheet type of sheets accommodated in the specified sheet accommodation unit does not match the print conditions in the target job, printing is performed using sheets in the specified sheet accommodation unit. Therefore, in this case, the sheet information obtaining unit 264 obtains information about the sheet type of sheets accommodated in the sheet accommodation unit specified in the target job, that is, information about the sheet type of sheets used in actual printing. In other words, a rule of obtaining information about the sheet type of sheets accommodated in a sheet accommodation unit specified in the target job is regarded as the predetermined rule.

The condition-specific speed table storage unit 265 stores a table (hereinafter referred to as “condition-specific speed table”) that includes a print speed (for example, the number of pages (sheets) on which printing is performed per minute) for each of the various conditions for the image forming apparatus 200. In the condition-specific speed table, a print speed is specified for each sheet type including a sheet size (sheet length), paper type, weight (basis weight), and so on. The print speed may be specified for each type of sheet accommodation unit that is used in printing, that is, for the sheet feeding unit 221 and for the manual feeding unit 227, or may be specified for each model of the image forming apparatus 200.

The print time calculation unit 266 calculates the print time for a target job on the basis of the print conditions specified in the target job and the sheet information obtained by the sheet information obtaining unit 264. More specifically, the print time calculation unit 266 selects a print speed from among the print speeds for respective conditions retained in the condition-specific speed table on the basis of the print conditions specified in the target job and the sheet information obtained by the sheet information obtaining unit 264. Subsequently, the print time calculation unit 266 calculates the print time for the target job while assuming that printing is performed for the number of sheets calculated by the number-of-sheets calculation unit 261 at the print speed selected from the condition-specific speed table.

To select a print speed, for example, information about, for example, a type of sheet accommodation unit that is used in printing is grasped from the print conditions specified in the target job. Further, information about a sheet type including the sheet size, paper type, and weight is grasped from the sheet information obtained by the sheet information obtaining unit 264. Then, a print speed that matches the grasped information is selected from the condition-specific speed table. Accordingly, a print speed that is used in a case where printing is performed on sheets that are identified with the sheet information obtained by the sheet information obtaining unit 264 is selected from the condition-specific speed table.

As described above, there may be a case where none of the sheet types of sheets accommodated in the sheet accommodation units match the print conditions specified in the target job. In this case, if a sheet accommodation unit that is used in printing is not specified, the sheet information obtaining unit 264 obtains information about a sheet type that is different from the sheet type of sheets that are actually used in printing for the target job. At this time, only information obtained by the sheet information obtaining unit 264 may be used as the information about a sheet type, or the print conditions specified in the target job may also be reflected.

For example, a case is assumed where the first-sheet size in a target job is “A5” but “A5” sheets are not accommodated and where the sheet information obtaining unit 264 obtains information about “A4” sheets as a sheet size closest to the “A5” size among the sheet sizes of sheets accommodated in the sheet accommodation units. In such a case where the first-sheet size in the target job, that is, the “A5” size, is different from the sheet size “A4” obtained by the sheet information obtaining unit 264, the print time calculation unit 266 may select a print speed in accordance with the condition of “A4” size or may select a print speed in accordance with the condition of “A5” size by reflecting information in the target job. Here, as an item for sheet identification, for example, the item of sheet size is used.

The print time transmission unit 267 transmits the print time calculated by the print time calculation unit 266 to the server apparatus 100.

The print time is calculated for each print job retained in the image forming apparatus 200. That is, processing performed by the number-of-sheets calculation unit 261, the first-sheet size calculation unit 262, the sheet information obtaining unit 264, and the print time calculation unit 266 is performed for each print job retained in the image forming apparatus 200.

Each of the functional units of the image forming apparatus 200 is implemented by software and hardware resources working together. Specifically, in a case where the image forming apparatus 200 is implemented in accordance with the configurations illustrated in FIG. 2 to FIG. 4, an operating system (OS) program and application programs stored in, for example, the ROM 242 are loaded to the RAM 243 and executed by the CPU 241 to thereby implement each of the functional units including the number-of-sheets calculation unit 261, the first-sheet size calculation unit 262, the sheet information obtaining unit 264, the print time calculation unit 266, and the print time transmission unit 267. The sheet information storage unit 263 and the condition-specific speed table storage unit 265 are implemented as, for example, the HDD 245.

In this exemplary embodiment, the sheet information obtaining unit 264 is used as an example of the obtaining unit, and the print time calculation unit 266 is used as an example of the calculation unit.

### Description of Condition-Specific Speed Table

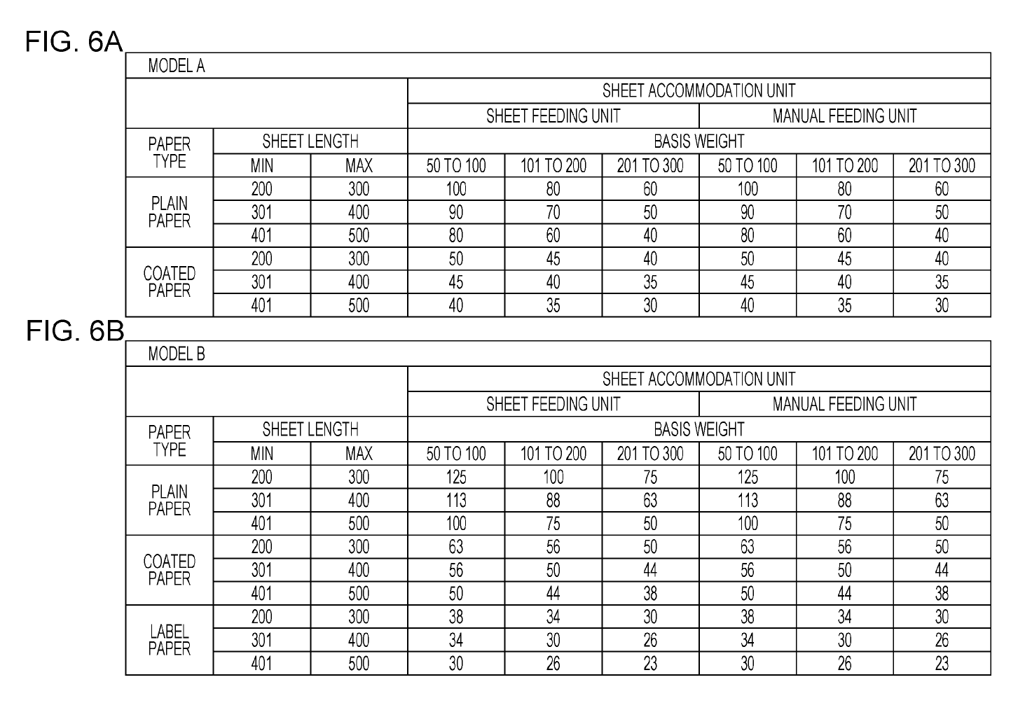

Now, the condition-specific speed table stored in the condition-specific speed table storage unit 265 is described. FIGS. 6A and 6B are diagrams illustrating example condition-specific speed tables.

The condition-specific speed table illustrated in FIG. 6A is a condition-specific speed table that is used in the image forming apparatus 200A of a model A. In the condition-specific speed table illustrated in FIG. 6A, a print speed is specified for each sheet size (sheet length), each paper type, each basis weight, and each type of sheet accommodation unit.

For example, the sheet lengths include a length from 200 to 300 mm, a length from 301 to 400 mm, and a length from 401 to 500 mm. The paper types include plain paper and coated paper. The basis weights include a weight from 50 to 100 g, a weight from 101 to 200 g, and a weight from 201 to 300 g. The types of sheet accommodation units include the sheet feeding unit 221 and the manual feeding unit 227. For each of these conditions, a print speed is specified. The unit of print speed is ppm (pages per minute) that represents the number of pages (sheets) on which printing is performed per minute.

The condition-specific speed table illustrated in FIG. 6B is a condition-specific speed table that is used in the image forming apparatus 200C of a model B. In this exemplary embodiment, the sheet types that are usable may differ depending on the model of the image forming apparatus 200, or the print speed may differ depending on the model even if the same sheets are used. Therefore, a condition-specific speed table is specified for each model. In the condition-specific speed table illustrated in FIG. 6B, a print speed is specified for each sheet size (sheet length), each paper type, each basis weight, and each type of sheet accommodation unit as in the condition-specific speed table illustrated in FIG. 6A.

As described above, in the condition-specific speed table, a print speed is specified for each of the various conditions for the image forming apparatus 200. In each image forming apparatus 200, a condition-specific speed table that corresponds to the model of the image forming apparatus 200 is stored in the condition-specific speed table storage unit 265.

The condition-specific speed tables illustrated in FIGS. 6A and 6B are examples, and all of the conditions illustrated in FIGS. 6A and 6B need not be specified in a condition-specific speed table. For example, a print speed need not be separately specified for each of the paper types, such as “plain paper”, “coated paper”, and “label paper”, or a print speed need not be separately specified for each of the types of sheet accommodation units, such as “sheet feeding unit 221” and “manual feeding unit 227”. The conditions specified in a condition-specific speed table are not limited to those illustrated in FIGS. 6A and 6B, and other conditions may be specified.

### Procedure for Calculating Print Time

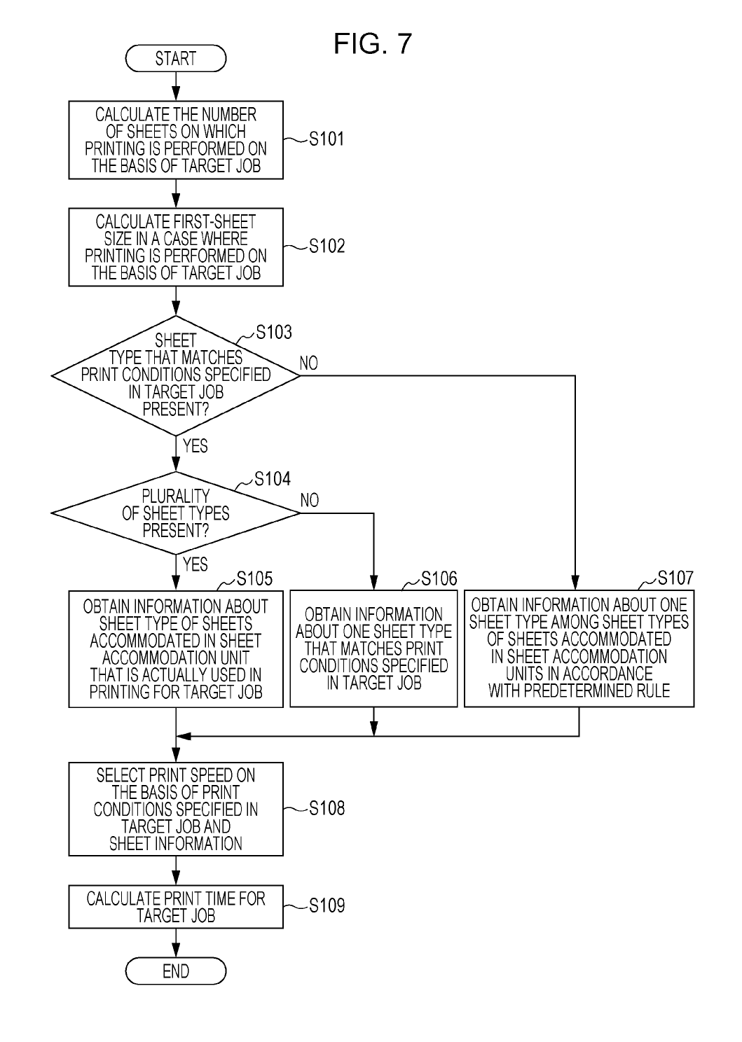

Now, a procedure for the control device 240 of the image forming apparatus 200 to calculate a print time is described. FIG. 7 is a flowchart illustrating an example procedure for the control device 240 of the image forming apparatus 200 to calculate a print time.

The process illustrated in FIG. 7 is performed when, for example, the administrator gives an instruction from the server apparatus 100 to the image forming apparatus 200, or may be performed, for example, at predetermined time intervals (for example, every hour). All print jobs retained by the image forming apparatus 200 may be targets of the process illustrated in FIG. 7, and the process is performed for, for example, all of the print jobs. For a print job for which the print time was calculated in the past, the print time need not be recalculated. However, in a case where the print job has been edited or sheets accommodated in the sheet accommodation units have been changed, the print time calculated in the past may change. Therefore, in the case where the print job has been edited or sheets accommodated in the sheet accommodation units have been changed, the print time may be recalculated even if the print time was calculated in the past.

The process illustrated in FIG. 7 may be performed, for example, at the timing when a print job is input to the image forming apparatus 200 or at the timing when a print job is edited. In this case, the print time is calculated for the print job input to the image forming apparatus 200, or the print time is calculated for the edited print job.

First, the number-of-sheets calculation unit 261 calculates the number of sheets on which printing is performed on the basis of the target job (step S101). Next, the first-sheet size calculation unit 262 calculates the first-sheet size in a case where printing is performed on the basis of the target job (step S102). Next, the sheet information obtaining unit 264 refers to information stored in the sheet information storage unit 263 and determines whether the sheet types of sheets accommodated in the sheet accommodation units include a sheet type that matches print conditions specified in the target job (step S103).

If the determination in step S103 results in positive determination (YES in step S103), the sheet information obtaining unit 264 further determines whether a plurality of sheet types match the print conditions specified in the target job (step S104). If the determination in step S104 results in positive determination (YES in step S104), the sheet information obtaining unit 264 obtains information about the sheet type of sheets accommodated in the sheet accommodation unit that is actually used in printing for the target job among the plurality of sheet types that match the print conditions specified in the target job (step S105). If the determination in step S104 results in negative determination (NO in step S104), one sheet type matches the print conditions specified in the target job among the sheet types of sheets accommodated in the sheet accommodation units. Accordingly, the sheet information obtaining unit 264 obtains information about the one sheet type (step S106).

If the determination in step S103 results in negative determination (NO in step S103), the sheet information obtaining unit 264 obtains information about one sheet type among the sheet types of sheets accommodated in the sheet accommodation units in accordance with a predetermined rule (step S107). For example, the sheet information obtaining unit 264 obtains information about the sheet type of sheets having a size closest to the first-sheet size in the target job among the sheet types of sheets accommodated in the sheet accommodation units.

After step S105, step S106, or step S107, the print time calculation unit 266 selects a print speed from among the print speeds for the respective conditions retained in the condition-specific speed table on the basis of the print conditions specified in the target job and the sheet information (information about the sheet type) obtained by the sheet information obtaining unit 264 (step S108). Next, the print time calculation unit 266 calculates the print time for the target job while assuming that printing is performed for the number of sheets calculated in step S101 at the print speed selected from the condition-specific speed table (step S109), and the process flow ends. In a case where another target job is present, the process from step S101 to step S109 is repeated also for the other target job.

### SPECIFIC EXAMPLES OF PROCEDURE FOR CALULATING PRINT TIME

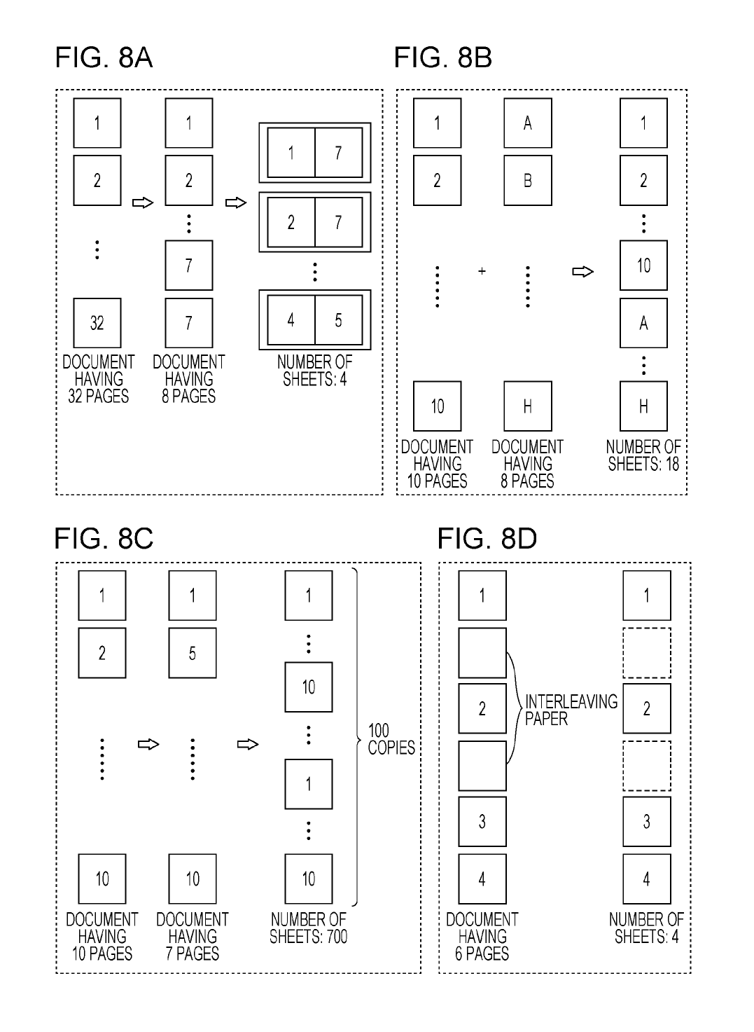

Now, a procedure for the control device 240 of the image forming apparatus 200 to calculate a print time is described with reference to FIGS. 8A to 8D to FIG. 12 by using specific examples. The steps mentioned below correspond to the steps illustrated in FIG. 7.

First, the number-of-sheets calculation unit 261 calculates the number of sheets on which printing is performed on the basis of the target job (step S101). FIGS. 8A to 8D are diagrams for describing specific example processes for calculating the number of sheets on which printing is performed on the basis of a target job.

In the example illustrated in FIG. 8A, a document has 32 pages in total and is edited so that the eighth and subsequent pages are deleted and the seventh page is copied to the eighth page. As the imposition/bookbinding method, a setting of “saddle stitching” is specified. As illustrated in FIG. 8A, the eighth and subsequent pages among 32 pages are deleted, and the number of pages decreases to seven. The seventh page is copied to the eighth page, and the number of pages increases to eight. Further, the setting of “saddle stitching” is specified as the imposition/bookbinding method. Therefore, images for two pages are printed on each sheet, and the sheets are folded in half along the center line of the sheets. As a result, the calculated number of sheets based on the target job is four.

In the example illustrated in FIG. 8B, two print jobs are concatenated due to a build job. As illustrated in FIG. 8B, a print job including a document having ten pages and a print job including a document having eight pages are concatenated. As a result, the calculated number of sheets based on the target job is 18.

In the example illustrated in FIG. 8C, a print range is specified for data of a document included in a print job with a print range specification. As illustrated in FIG. 8C, for a print job including a document having ten pages, the first page and the fifth and subsequent pages are specified as pages that are included in the print range. With this print range specification, the number of pages of the document to be printed is seven. Further, the number of copies to be printed is set to 100. As a result, the calculated number of sheets based on the target job is 700.

Here, a case where RIP processing has been performed for a target job is described. In the example illustrated in FIG. 8D, in a print job including a document having six pages, the second page and the fourth page are each set as a piece of interleaving paper. In a case where an analysis has been performed for all of the pages of the document in the RIP processing, it is known that the second page and the fourth pages are pieces of interleaving paper and that a process for forming image data is not performed for the pages. Therefore, as illustrated in FIG. 8D, two pages are removed from the print job including the document of six pages. As a result, the calculated number of sheets based on the target job is four. Accordingly, in the case where RIP processing has been performed, the number of sheets based on the target job is calculated more accurately.

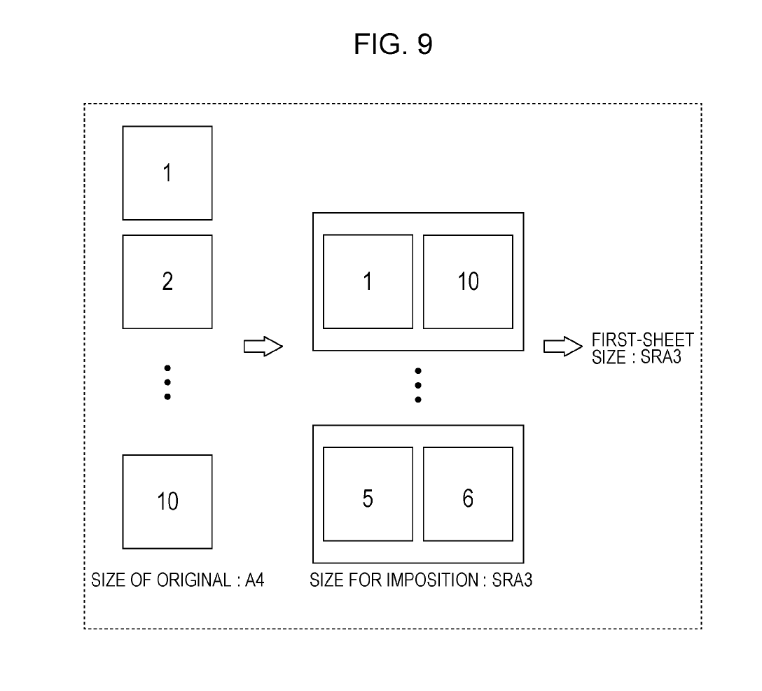

Next, the first-sheet size calculation unit 262 calculates the first-sheet size in a case where printing is performed on the basis of the target job (step S102). FIG. 9 is a diagram for describing a specific example process for calculating the first-sheet size in the case where printing is performed on the basis of a target job. As illustrated in FIG. 9, in the target job, the size of an original that is printed first is specified as “A4”. Further, the imposition/bookbinding method is specified as “saddle stitching”, and the size for imposition is specified as “SRA3”. In this case, the calculated first-sheet size is “SRA3”.

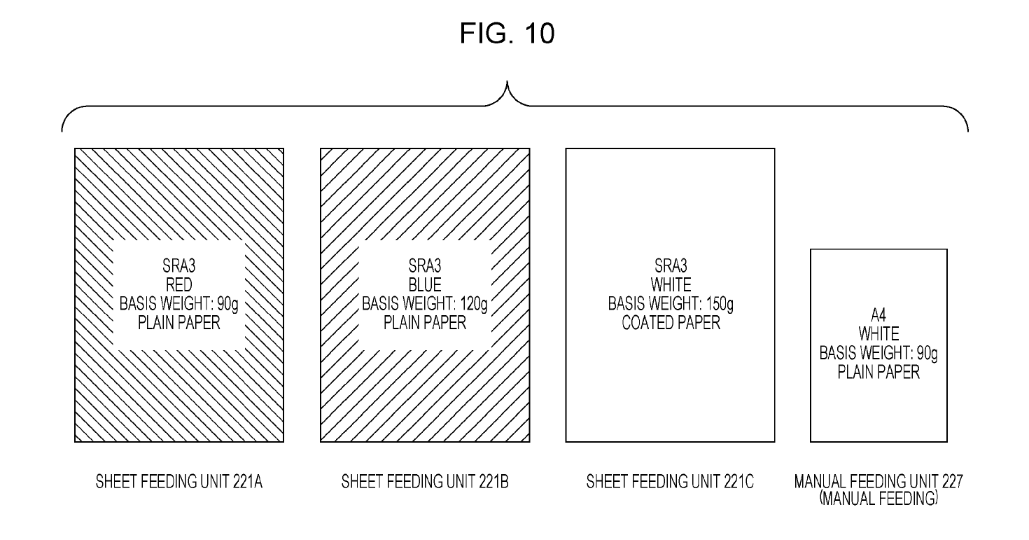

Next, the sheet information obtaining unit 264 obtains information about the sheet type of sheets accommodated in a sheet accommodation unit from the sheet information storage unit 263. FIG. 10 is a diagram illustrating example sheets accommodated in sheet accommodation units. FIG. 10 illustrates an example of four sheet accommodation units, namely, a sheet feeding unit 221A, a sheet feeding unit 221B, a sheet feeding unit 221C, and the manual feeding unit 227.

The sheet feeding unit 221A accommodates sheets of a sheet size “SRA3”, a sheet color “red”, a sheet weight “basis weight 90 g”, and a paper type “plain paper”. The sheet feeding unit 221B accommodates sheets of the sheet size “SRA3”, a sheet color “blue”, a sheet weight “basis weight 120 g”, and the paper type “plain paper”. The sheet feeding unit 221C accommodates sheets of the sheet size “SRA3”, a sheet color “white”, a sheet weight “basis weight 150 g”, and a paper type “coated paper”. The manual feeding unit 227 accommodates sheets of a sheet size “A4”, the sheet color “white”, the sheet weight “basis weight 90 g”, and the paper type “plain paper”. Sheet information as described above is stored in the sheet information storage unit 263.

Here, a first example is assumed in which print conditions specified in a target job include a first-sheet size “SRA3”, a sheet accommodation unit “to be automatically selected”, and a sheet color “red”. The sheet accommodation unit “to be automatically selected” means that a specific sheet accommodation unit is not specified in the target job. Among the sheets illustrated in FIG. 10, only the sheets accommodated in the sheet feeding unit 221A match the print conditions, and the other sheets do not match the print conditions. Therefore, the sheet information obtaining unit 264 obtains sheet information about the sheets accommodated in the sheet feeding unit 221A (YES in step S103, NO in step S104, and step S106). That is, the sheet information obtaining unit 264 obtains information about the sheet type including the sheet size “SRA3”, the sheet color “red”, the sheet weight “basis weight 90 g”, and the paper type “plain paper”.

Next, a second example is assumed in which print conditions specified in a target job include a first-sheet size “SRA3” and a sheet accommodation unit “sheet feeding unit 221B”. Among the sheets illustrated in FIG. 10, only the sheets accommodated in the sheet feeding unit 221B match the print conditions, and the other sheets do not match the print conditions. Therefore, the sheet information obtaining unit 264 obtains sheet information about the sheets accommodated in the sheet feeding unit 221B (YES in step S103, NO in step S104, and step S106). That is, the sheet information obtaining unit 264 obtains information about the sheet type including the sheet size “SRA3”, the sheet color “blue”, the sheet weight “basis weight 120 g”, and the paper type “plain paper”.

Next, a third example is assumed in which print conditions specified in a target job include a first-sheet size “A3” and a sheet accommodation unit “sheet feeding unit 221B”. None of the sheets illustrated in FIG. 10 have a sheet size “A3”, that is, sheets that match the print conditions are not present. However, “sheet feeding unit 221B” is specified in the target job. Therefore, the sheet information obtaining unit 264 obtains sheet information about the sheets accommodated in the sheet feeding unit 221B (NO in step S103 and step S107).

Next, a fourth example is assumed in which print conditions specified in a target job include a first-sheet size “A5”, a basis weight “120 g”, and a sheet accommodation unit “to be automatically selected”. None of the sheets illustrated in FIG. 10 have a sheet size “A5”, that is, sheets that match the print conditions are not present. Therefore, the sheet information obtaining unit 264 obtains information about one sheet type in accordance with a predetermined rule. For example, the sheet information obtaining unit 264 obtains sheet information about the sheets accommodated in the manual feeding unit 227, which accommodates sheets having a “A4” size that is closest to the first-sheet size “A5” (NO in step S103 and step S107). That is, the sheet information obtaining unit 264 obtains information about the sheet type including the sheet size “A4”, the sheet color “white”, the sheet weight “basis weight 90 g”, and the paper type “plain paper”.

Next, a fifth example is assumed in which print conditions specified in a target job include a first-sheet size “SRA3” and a sheet accommodation unit “to be automatically selected”. Among the sheets illustrated in FIG. 10, the sheets accommodated in the sheet feeding units 221A to 221C match the print conditions. Therefore, the sheet information obtaining unit 264 obtains information about the sheet type of sheets accommodated in the sheet accommodation unit that is actually used in printing for the target job.

For example, in a case where it is specified that the sheet feeding unit 221A, the sheet feeding unit 221B, or the sheet feeding unit 221C is to be preferentially used in this order as a sheet accommodation unit, the sheet feeding unit 221A is used in actual printing. Therefore, the sheet information obtaining unit 264 obtains sheet information about the sheets accommodated in the sheet feeding unit 221A (YES in step S103, YES in step S104, and step S105). For example, in a case where it is specified that white sheets are to be used, the sheet feeding unit 221C is used in actual printing. Therefore, the sheet information obtaining unit 264 obtains sheet information about the sheets accommodated in the sheet feeding unit 221C. On the basis of a predetermined setting as described above, the sheet accommodation unit that is to be used in actual printing is determined.

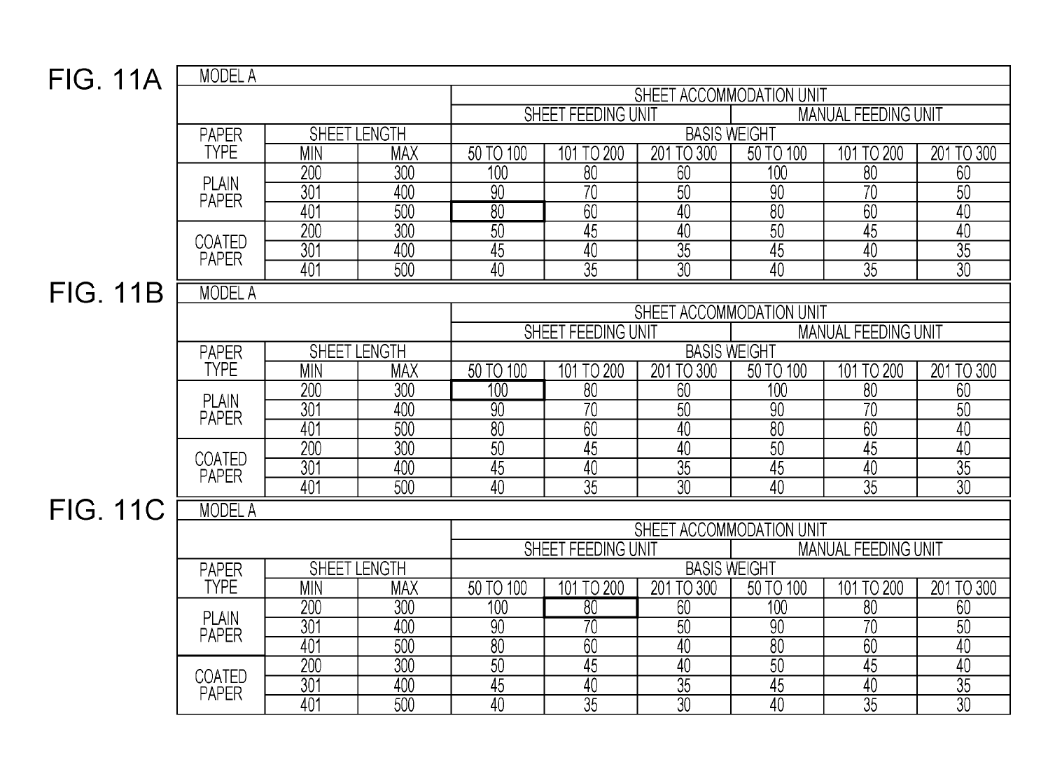

Next, the print time calculation unit 266 selects a print speed from the condition-specific speed table (step S108). FIGS. 11A to 11C are diagrams for describing example processes for selecting a print speed. Here, it is assumed that the image forming apparatus 200 is a model A and that the condition-specific speed table illustrated in FIG. 6A is used.

For example, in the first example described above, the sheet information obtaining unit 264 obtains information including the sheet accommodation unit “sheet feeding unit 221A”, the sheet size “SRA3”, the sheet color “red”, the sheet weight “basis weight 90 g”, and the paper type “plain paper”. The sheet size “SRA3” measures 320 mm×450 mm, and therefore, the sheet length is “450 mm”. On the basis of these pieces of information, the print time calculation unit 266 selects a print speed 80 ppm from the condition-specific speed table as illustrated in FIG. 11A.

In the fourth example described above, sheets that match the print conditions specified in the target job are not present, and a specific sheet accommodation unit is not specified in the target job. In this case, the sheet information obtaining unit 264 obtains information about a sheet type that is different from the sheet type of sheets that are actually used in printing for the target job. The print time calculation unit 266 may use only the information obtained by the sheet information obtaining unit 264 as the information about a sheet type; however, the print time calculation unit 266 may further take into consideration the print conditions specified in the target job.

Specifically, the information obtained by the sheet information obtaining unit 264 includes the sheet accommodation unit “manual feeding unit 227”, the sheet size “A4”, the sheet color “white”, the sheet weight “basis weight 90 g”, and the paper type “plain paper”. The sheet size “A4” measures 210 mm×297 mm, and therefore, the sheet length is “297 mm”. On the basis of these pieces of information, the print time calculation unit 266 may select a print speed from the condition-specific speed table. In this case, the print time calculation unit 266 selects a print speed 100 ppm, as illustrated in FIG. 11B.

In the case of taking into consideration the print conditions specified in the target job, “A5”, which is the first-sheet size, is used as the sheet size instead of “A4”. The sheet size “A5” measures 148 mm×210 mm, and therefore, the sheet length is “210 mm”. Further “basis weight 120 g” is used instead of “basis weight 90 g”. On the basis of these pieces of information, the print time calculation unit 266 selects a print speed 80 ppm from the condition-specific speed table, as illustrated in FIG. 11C.

Next, the print time calculation unit 266 calculates the print time (step S109). For example, in a case where the number of sheets calculated by the number-of-sheets calculation unit 261 in step S101 is 100 and the print speed selected by the print time calculation unit 266 is 80 ppm, the calculated print time is 75 seconds (100 pages/(80 ppm/60 seconds)=75).

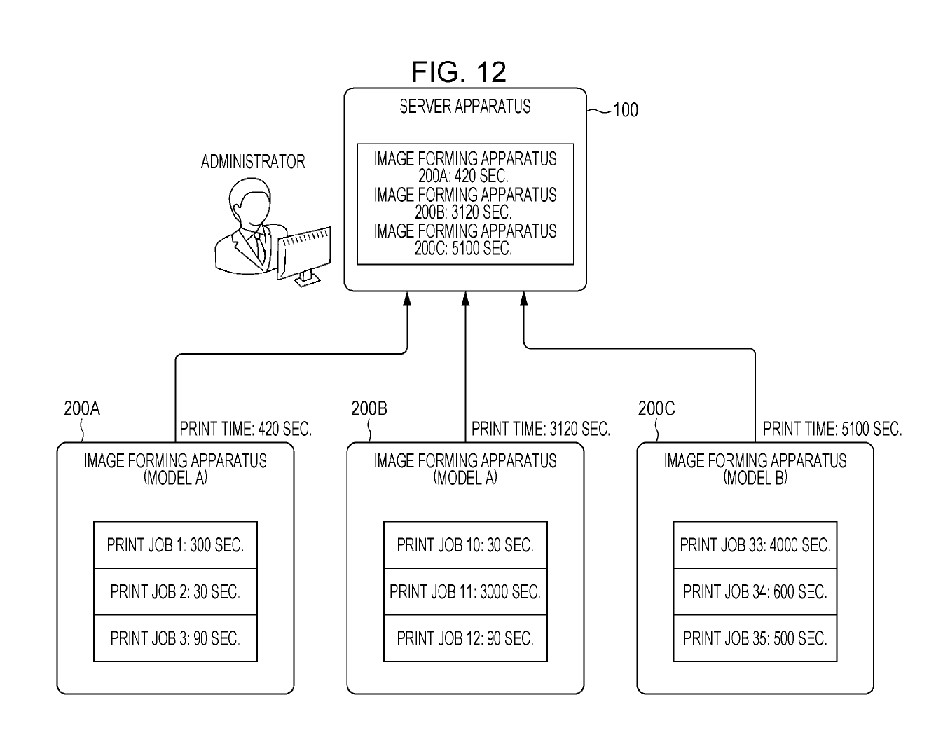

The print time transmission unit 267 transmits the print time calculated by the print time calculation unit 266 to the server apparatus 100. FIG. 12 is a diagram for illustrating an example process for transmitting the print time to the server apparatus 100. In this example, the image forming apparatus 200A retains print jobs 1 to 3, the calculated print times for the print jobs 1 to 3 are 300 seconds, 30 seconds, and 90 seconds respectively, and the total print time is 420 seconds. The print time transmission unit 267 of the image forming apparatus 200A transmits the print time (420 seconds) to the server apparatus 100. Here, the print time transmission unit 267 may transmit the print time for each print job.

The image forming apparatus 200B retains print jobs 10 to 12, the calculated print times for the print jobs 10 to 12 are 30 seconds, 3000 seconds, and 90 seconds respectively, and the total print time is 3120 seconds, which is transmitted to the server apparatus 100. The image forming apparatus 200C retains print jobs 33 to 35, the calculated print times for the print jobs 33 to 35 are 4000 seconds, 600 seconds, and 500 seconds respectively, and the total print time is 5100 seconds, which is transmitted to the server apparatus 100.

The server apparatus 100 displays the collected print times of the respective image forming apparatuses 200 on, for example, a screen to inform the administrator of the print times. The administrator checks and uses the print times of the respective image forming apparatuses 200 to schedule a print operation. The print time of the image forming apparatus 200A is shortest among the three image forming apparatuses 200, and therefore, for example, the administrator plans to transmit a print job preferentially to the image forming apparatus 200A.

For example, the administrator may transmit a print job to the respective image forming apparatuses 200 to calculate the print times at the respective image forming apparatuses 200 for the print job and may compare the calculated print times. In this case, when printing for the print job is actually performed, the server apparatus 100 instructs the image forming apparatus 200 for which the print time is shortest to perform printing.

As described above, the image forming apparatus 200 according to this exemplary embodiment calculates the print time for a print job on the basis of print conditions specified in the print job and sheet information about sheets accommodated in a sheet accommodation unit. For example, there may be a case where a sheet size is specified in a print job, but the print job does not include information, such as a paper type and a basis weight, for calculating the print time. In this exemplary embodiment, the image forming apparatus 200 refers to sheet information about sheets accommodated in the sheet accommodation units on the basis of the print conditions specified in the print job and obtains information, such as a paper type and a basis weight, for calculating the print time. Therefore, when the image forming apparatus 200 according to this exemplary embodiment is used, the print time is calculated more accurately than in a configuration in which the print time is calculated on the basis of the print conditions specified in the print job without, for example, obtaining sheet information about sheets accommodated in a sheet accommodation unit.

The image forming apparatus 200 obtains sheet information about sheets accommodated in a sheet accommodation unit by using print conditions for a page that is printed first, such as the first-sheet size. For example, there may be a case where a print job includes a page that is specified to be printed in a sheet size different from the first-sheet size. However, it takes long to know the sheet sizes of all pages from the first page to the last page of the document included in the print job. In this exemplary embodiment, the print time is calculated by using print conditions for a page that is printed first to thereby make a time taken to calculate the print time shorter than that in a configuration in which, for example, print conditions for a page other than the page that is printed first are used.

However, in this exemplary embodiment, print conditions for a page other than the page that is printed first may be used. In this case, the image forming apparatus 200 obtains sheet information about sheets accommodated in a sheet accommodation unit in accordance with each page of the document included in the target job to calculate the print time.

In a case where a print job has been edited, the image forming apparatus 200 calculates the print time for the edited print job.

In a case where the image forming apparatus 200 calculates the print time for a print job for which RIP processing has been performed, the print time is calculated more accurately than in a case where RIP processing has not been performed.

In this exemplary embodiment, while performing RIP processing or print processing for a print job, the image forming apparatus 200 may calculate the print time for another print job in parallel to the RIP processing or print processing.

### Description of Applicable Computer

In this exemplary embodiment, the example of using the image forming apparatus 200 has been described; however, an apparatus for implementing the process for calculating the print time according to this exemplary embodiment is not limited to the image forming apparatus 200. The process for calculating the print time according to this exemplary embodiment may be implemented by using, for example, a general-purpose computer that is connected to the image forming apparatus 200. Here, it is assumed that the process for calculating the print time is implemented by using a computer 400, and the hardware configuration of the computer 400 will be described.

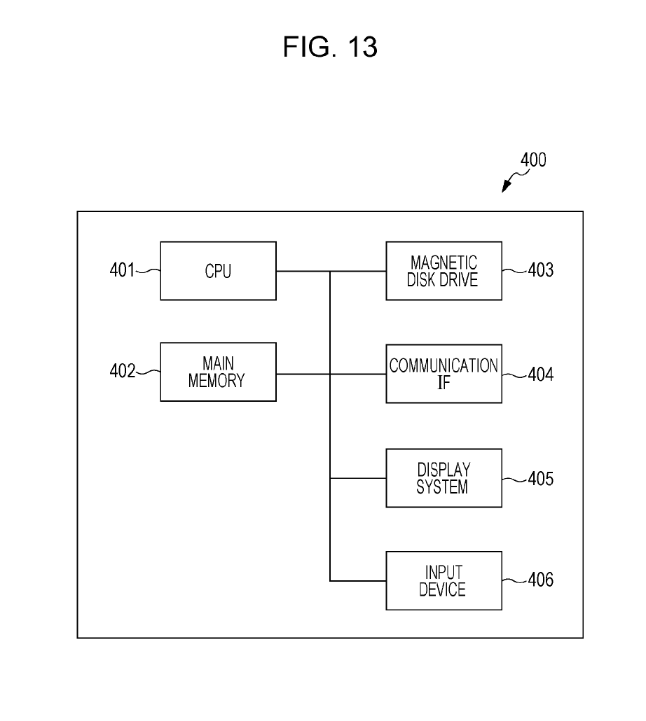

FIG. 13 is a diagram illustrating an example hardware configuration of the computer 400 to which this exemplary embodiment is applicable. In this exemplary embodiment, the computer 400 is used as an example of the information processing apparatus.

The computer 400 includes a CPU 401, which is an arithmetic means, a main memory 402, which is a storage means, and a magnetic disk drive (or HDD) 403. The CPU 401 executes various programs including an OS and application. The main memory 402 is a memory area for storing, for example, various programs and data that is used in execution of the programs. The magnetic disk drive 403 stores a program for implementing each functional unit illustrated in FIG. 5. The program is loaded to the main memory 402, and processing based on the program is performed by the CPU 401 to thereby implement each of the functional units including the number-of-sheets calculation unit 261, the first-sheet size calculation unit 262, the sheet information obtaining unit 264, the print time calculation unit 266, and the print time transmission unit 267. The sheet information storage unit 263 and the condition-specific speed table storage unit 265 are implemented as, for example, the magnetic disk drive 403.

The computer 400 further includes a communication IF 404 for external communication, a display system 405 constituted by a video memory, a display, and so on, and an input device 406, such as a keyboard or a mouse.

The program for implementing the exemplary embodiment of the present disclosure may be provided via a communication means, as a matter of course, or may be stored in a recording medium, such as a compact disc read-only memory (CD-ROM), and provided.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an obtaining unit that obtains sheet information about sheets accommodated in a sheet accommodation unit among sheet accommodation units in accordance with a print condition specified in a print instruction; and
a calculation unit that calculates a time taken to perform printing in accordance with the print instruction on the basis of the print condition and the sheet information.

2. The information processing apparatus according to claim 1, wherein
the obtaining unit obtains, as the sheet information, information about a sheet type of the sheets accommodated in the sheet accommodation unit, the sheet type matching the print condition.

3. The information processing apparatus according to claim 2, wherein
in a case where a plurality of sheet types match the print condition among sheet types of sheets accommodated in the sheet accommodation units, the obtaining unit obtains information about a sheet type of sheets accommodated in a sheet accommodation unit that is actually used in printing performed in accordance with the print instruction.

4. The information processing apparatus according to claim 2, wherein
in a case where no sheet types match the print condition among sheet types of sheets accommodated in the sheet accommodation units, the obtaining unit obtains information about one sheet type among the sheet types of the sheets accommodated in the sheet accommodation units in accordance with a predetermined rule.

5. The information processing apparatus according to claim 4, wherein
the obtaining unit obtains information about a sheet type of sheets having a sheet size closest to a sheet size of a page that is printed first in accordance with the print instruction among the sheet types of the sheets accommodated in the sheet accommodation units.

6. The information processing apparatus according to claim 4, wherein
in a case where a sheet accommodation unit that is actually used in printing is specified in the print instruction, the obtaining unit obtains information about a sheet type of sheets accommodated in the specified sheet accommodation unit.

7. The information processing apparatus according to claim 4, wherein
the obtaining unit obtains information about a sheet type that is different from a sheet type of sheets that are actually used in printing performed in accordance with the print instruction among the sheet types of the sheets accommodated in the sheet accommodation units.

8. The information processing apparatus according to claim 1, wherein
the calculation unit calculates the time taken to perform printing in accordance with the print instruction on the basis of a print speed that is used in a case where printing is performed on sheets that are identified with the sheet information.

9. The information processing apparatus according to claim 8, wherein
the print condition includes information about sheets that are used in printing performed in accordance with the print instruction, and
in a case where the information about sheets included in the print condition is different from the sheet information with regard to an item for sheet identification, the calculation unit calculates the time taken to perform printing in accordance with the print instruction on the basis of a print speed that is used in a case where printing is performed on sheets that are identified by reflecting the information about sheets included in the print condition with regard to the item.

10. The information processing apparatus according to claim 1, wherein
even in a case where the print instruction includes a page that is printed in accordance with a print condition different from a print condition for a page that is printed first, the obtaining unit obtains the sheet information in accordance with the print condition for the page that is printed first.

11. The information processing apparatus according to claim 10, wherein even in a case where the print instruction includes a page that is printed in a sheet size different from a sheet size of the page that is printed first, the obtaining unit obtains the sheet information in accordance with the sheet size of the page that is printed first.

12. A non-transitory computer readable medium storing a program causing a computer to execute a process for information processing, the process comprising:
obtaining sheet information about sheets accommodated in a sheet accommodation unit among sheet accommodation units in accordance with a print condition specified in a print instruction; and
calculating a time taken to perform printing in accordance with the print instruction on the basis of the print condition and the sheet information.

13. An information processing apparatus comprising:
obtaining means for obtaining sheet information about sheets accommodated in a sheet accommodation unit among sheet accommodation units in accordance with a print condition specified in a print instruction; and
calculation means for calculating a time taken to perform printing in accordance with the print instruction on the basis of the print condition and the sheet information.
